(19) United States
(12) Patent Application Publication
(10) Pub. No.: US 2024/0103605 A1
(43) Pub. Date: Mar. 28, 2024

(54) CONTINUOUS HAND POSE TRACKING WITH WRIST-WORN ANTENNA IMPEDANCE CHARACTERISTIC SENSING

(71) Applicant: Apple Inc., Cupertino, CA (US)

(72) Inventors: Istvan J. Szini, San Jose, CA (US); Chris Harrison, Pittsburgh, PA (US); Daehwa Kim, Yeongcheon (KR)

(21) Appl. No.: 17/952,138

(22) Filed: Sep. 23, 2022

(51) Int. Cl. G06F 3/01; H01Q 1/27; H01Q 9/16; H01Q 21/26; H01Q 25/00

(52) U.S. Cl. CPC G06F 3/011; G06F 3/017; H01Q 1/273; H01Q 9/16; H01Q 21/26; H01Q 25/00

(57) ABSTRACT

Embodiments are disclosed for a continuous hand pose tracking system employing at least one wrist-worn antenna, from which real-time dielectric loading resulting from different hand poses). The sensor data is interpreted by a machine learning backend, which outputs a fully-posed three-dimensional (3D) hand that can be continuously tracked. In some embodiments, two degrees of freedom (2DOF) wrist angle and micro-gestures are tracked. The hand pose tracking system can be extended to include two or more and/or different types of antennas operating at different self-resonances. In an embodiment, a method comprises: determining, with at least one processor of a wrist-worn device, a complex impedance characteristic variation based on a dynamic finite electric ground plane of at least one antenna coupled to the device; and predicting, with the at least one processor, a hand pose of a user wearing the device on a their wrist based on the determined complex impedance characteristic variation.

### TECHNICAL FIELD

This disclosure relates generally to hand pose tracking.

### BACKGROUND

Applications that use hand pose tracking are numerous, including virtual and augmented reality, spatial user interfaces, sign language recognition and context awareness. Existing wrist-worn hand pose systems use optical methods (e.g., RGB cameras, thermal cameras, range finders). These methods, however, are sensitive to occlusion from clothing and the user's hand itself in certain poses. Wrist-worn camera-based methods also innately carry privacy implications that can deter consumers.

### SUMMARY

Embodiments are disclosed for a continuous hand pose tracking system employing at least one wrist-worn antenna, from which real-time antenna complex impedance characteristics are used to predict different hand poses. The sensor data is interpreted by a machine learning backend, which outputs a fully-posed three-dimensional (3D) hand that can be continuously tracked by the system even when the hand is covered in fabric. In some embodiments, two degrees of freedom (DOF) wrist angle and micro-gestures are tracked. The hand pose tracking system can be extended to include two or more and/or different types of antennas operating at different self-resonant frequencies.

In an embodiment, a method comprises: determining, with at least one processor of a wrist-worn device, an impedance characteristic variation based on a dynamic finite electric ground plane of at least one antenna coupled to the device; and predicting, with the at least one processor, a hand pose of a user wearing the device on a their wrist based on the determined impedance characteristic variation.

In an embodiment, determining the impedance characteristic variation comprises: measuring return loss magnitude and complex impedance magnitude and phase shift for the at least one antenna as a function of frequency; and determining the impedance characteristic variation from the measured return loss magnitude and complex impedance magnitude and phase shift.

In an embodiment, the predicting is implemented using a machine learning model.

In an embodiment, the method further comprises: measuring return loss magnitude and complex impedance magnitude and phase shift for the at least one antenna as a function of frequency, and determining the impedance characteristic variation from the measured return loss magnitude and complex impedance magnitude and phase shift; computing a first derivative of the return loss magnitude and complex impedance magnitude and phase shift; determining an index of a lower value of return loss magnitude; computing a mean of the return loss magnitudes and phase shifts; computing a minimum and maximum of the return loss magnitudes and phase shifts; computing a standard deviation of the return loss magnitudes and phase shifts; and aggregating the first derivative, index of lower value of return loss magnitude, minimum, maximum and standard deviation into an input feature vector; and providing the input feature vector to the machine learning model.

In an embodiment, a hand input modality for training the machine learning model include images of hand poses.

In an embodiment, a hand input modality for training the machine learning model include images of wrist angles.

In an embodiment, a hand input modality for training the machine learning model include images of discrete hand locations.

In an embodiment, an apparatus comprises: at least one antenna; at least one processor coupled to the at least one antenna, the processor configured to perform operations comprising: determining a complex impedance characteristic variation based on a dynamic finite electric ground plane of at least one antenna coupled to the device; and predicting a hand pose of a user wearing the device on a their wrist based on the determined impedance characteristic variation based on the variation of the finite coupled ground plane created by the user hand gesture and dimension.

In an embodiment, the apparatus includes at least two antennas with different topologies.

In an embodiment, the apparatus includes at least two antennas with different resonant frequencies.

In an embodiment, the apparatus includes at least two antennas with different polarization.

In an embodiment, the apparatus includes at least two antennas with different antenna radiation patterns.

In an embodiment, the apparatus includes at least two antennas with different quality factors.

In an embodiment, the apparatus includes a distributed antenna array of two or more antennas.

In an embodiment, the apparatus includes at least two antennas that are coupled to the device such that they radiate in opposite directions.

In an embodiment, the at least one antenna is a cloverleaf antenna.

In an embodiment, the at least one antenna is a planar antenna

In an embodiment, the at least one antenna is a linear antenna

In an embodiment, the at least one antenna is a loop antenna

In an embodiment, the at least one antenna is an electric small antenna

In an embodiment, the apparatus is a smartwatch.

In an embodiment, the apparatus further comprises an attachment mechanism for attaching the apparatus to a wrist.

In an embodiment, a non-transitory, computer-readable storage medium storing instructions that when executed by the at least one processor, cause the at least one processor to preform operations comprising: determining an complex impedance characteristic variation based on a dynamic finite electric ground plane of at least one antenna coupled to a wrist-worn device; and predicting a hand pose of a user wearing the device based on the determined complex impedance characteristic variation.

In an embodiment, determining the impedance characteristic variation comprises: measuring return loss magnitude and complex impedance magnitude and phase shift for the at least one antenna as a function of frequency; and determining the complex impedance characteristic variation from the measured return loss magnitude and complex impedance magnitude and phase shift.

Other embodiments can include an apparatus, computing device and non-transitory, computer-readable storage medium.

Particular embodiments described herein provide one or more of the following advantages. The disclosed embodiments provide an alternative to optical hand pose tracking methods that are not sensitive to occlusion from clothing or the user's hand, and do not have the privacy concerns of optical methods.

The details of one or more implementations of the subject matter are set forth in the accompanying drawings and the description below. Other features, aspects and advantages of the subject matter will become apparent from the description, the drawings and the claims.

### BRIEF DESCRIPTION OF THE DRAWINGS

FIG. 1A is an example wrist-worn hand pose tracking device for continuous hand pose tracking with antenna impedance characteristic sensing, according to an embodiment.

FIG. 1B is a block diagram of a hand pose tracking processing pipeline, according to an embodiment.

FIGS. 2A-2C illustrate the wrist-worn device of FIG. 1A measuring the swept frequency return loss of two antennas for three exemplary hand poses, according to an embodiment.

FIGS. 3A-3D illustrate results from measurements and simulations of four antenna topologies, according to an embodiment.

FIGS. 4A-4H illustrate results from measurements and simulations of a cloverleaf antenna placed at eight positions on the wrist, according to an embodiment.

FIGS. 5A-5F illustrate results from measurements and simulations of a first cloverleaf antenna placed at the front position on the wrist, and a second cloverleaf antenna placed at one of five other positions on the wrist, according to an embodiment.

FIGS. 6A-6C illustrate simulation of electric field distribution for a cloverleaf antenna at the front position for three exemplary hand poses, according to an embodiment.

FIGS. 7A and 7B illustrate simulated electric field intensity distribution at resonance frequency when one antenna is placed at the front position on the wrist and the other antenna is placed at the left-back position on the wrist for three exemplary hand poses, according to an embodiment.

FIGS. 8A-8C show an S11 parameter sparkline and hand pose model output for eleven different hand poses, according to an embodiment.

FIG. 9 shows an S11 parameter sparkline and hand pose model output for five wrist flexions, according to an embodiment.

FIG. 10 is a flow diagram of a process of continuous hand pose tracking using wrist-worn antenna complex impedance characteristics sensing, according to an embodiment.

### DETAILED DESCRIPTION

### Sensing Principle

The disclosed embodiments leverage “loading mode” electric field sensing, in which a radiating element is sufficiently proximate to a human-body that the radiating element and human-body capacitively couple. The proximity of the radiating element to human tissue means the user becomes part of the radiated element ground plane. With a high frequency of operation and corresponding small wavelength, the coupled human tissue (e.g., wrist and hand) becomes less than a virtual infinite ground plane. At the frequency of operation, variation in hand pose changes the antenna finite ground plane, and any change in the hand pose manifests as a change in the antenna resultant wavelength, and thus the antenna's self-resonance frequency. The discrimination of hand poses is defined by the antenna complex impedance change at a predetermined frequency due to a self-resonance shift caused by alterations in the coupled virtual ground due to the hand pose. Depending on the antenna topology, this coupling effect can be varied and enhanced.

### Example Wrist-Worn Hand Pose Tracking Device

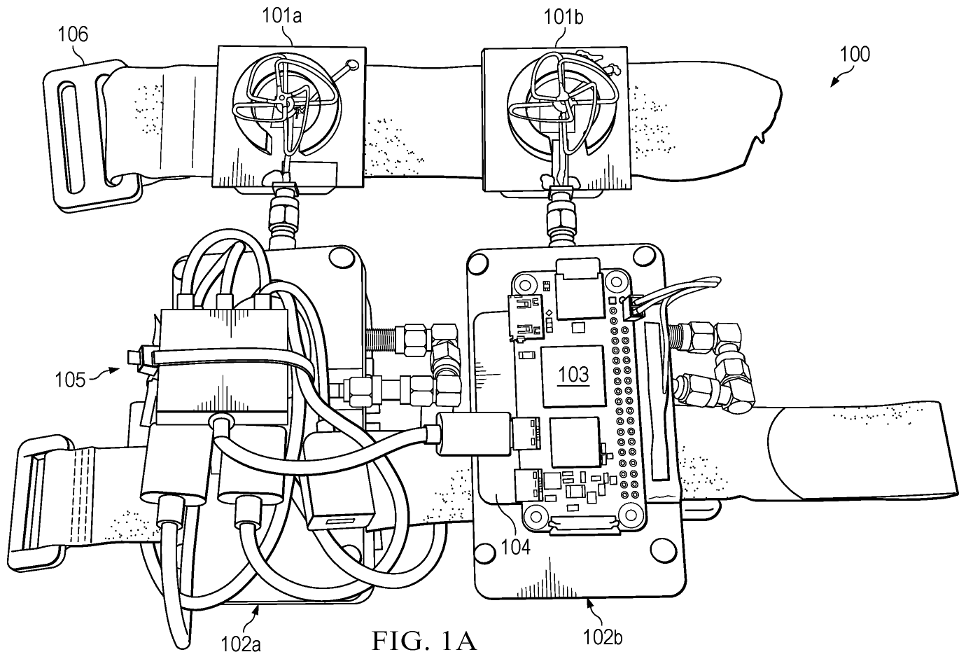

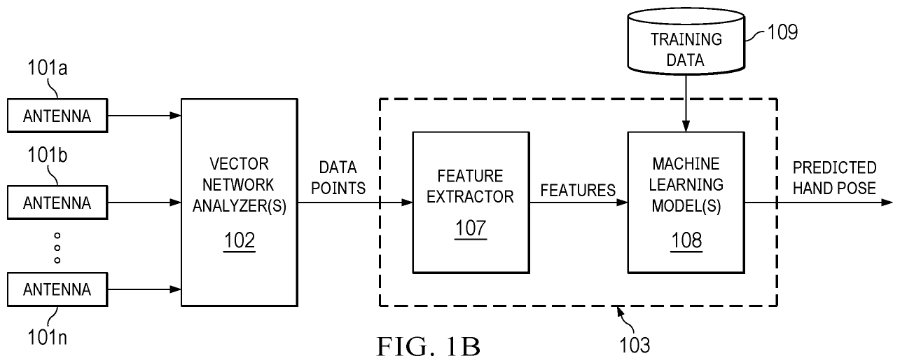

FIG. 1A is an example wrist-worn hand pose tracking device 100 for continuous hand pose tracking with antenna impedance characteristic sensing, according to an embodiment. Device 100 includes antennas 101a, 101b, vector network analyzers (VNAs) 102a, 102b, processor 103, power source 104 (e.g., a battery), communication port 105 (e.g., a USB port) and attachment device 106 (e.g., an elastic band, Velcro, etc.). The above components can be attached or coupled to a support structure (e.g., thick acrylic, printed circuit board, etc.), which is coupled to attachment device 106. Device 100 can be integrated into a housing for protection from the environment, electromagnetic (EM) shielding and/or aesthetics.

Note that device 100 is proof-of-concept hardware and therefore not optimized for size or aesthetics. In a commercial embodiment, a radio frequency (RF) multiplexer could allow for a single VNA to utilize two or more antennas, rather than having duplicate VNAs. In other embodiments, a single VNA could utilize two or more antennas to measure S11 and S22 parameters, which could be used to improve hand pose prediction. In some embodiments, to reduce size a single-chip VNA can be used, such as described in Chung, Hyunchul, Qian Ma, Mustafa Sayginer and Gabriel M. Rebeiz. “A Packaged 0.01-26-GHz Single-Chip SiGe Reflectometer for Two-Port Vector Network Analyzers.” IEEE Transactions on Microwave Theory and Techniques 68 (2020): 1794-1808.

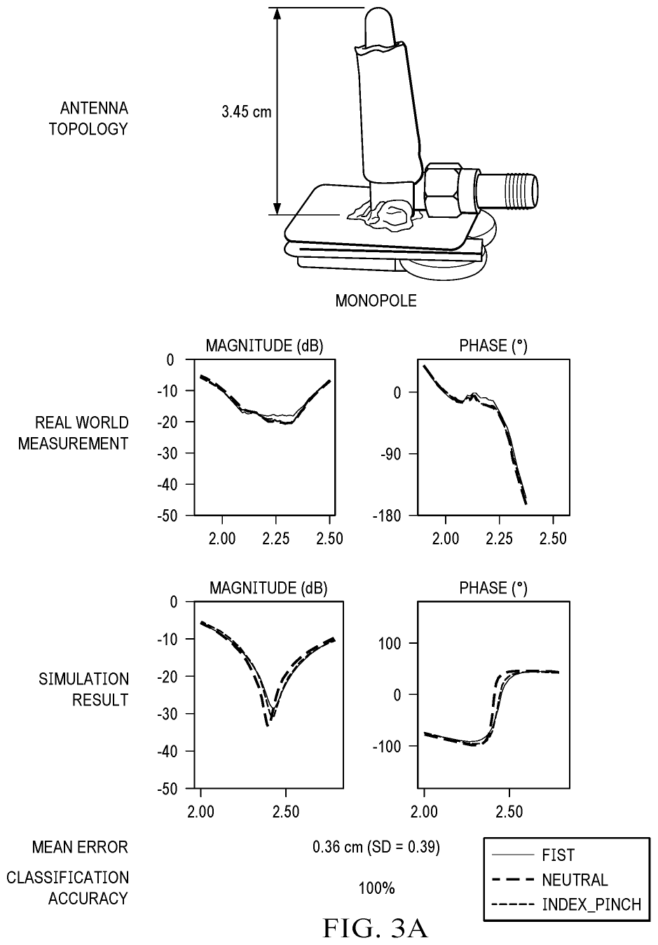

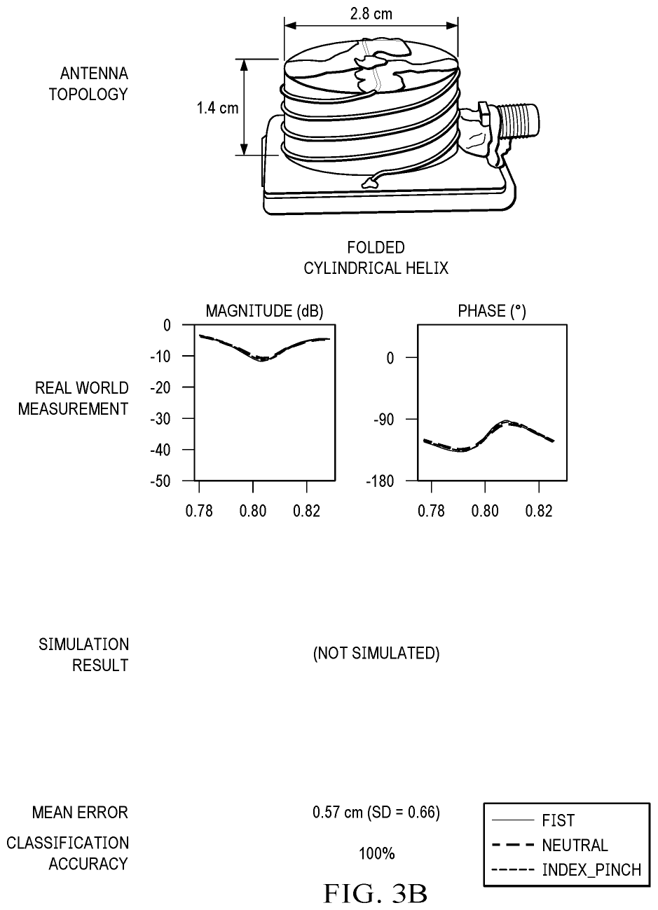

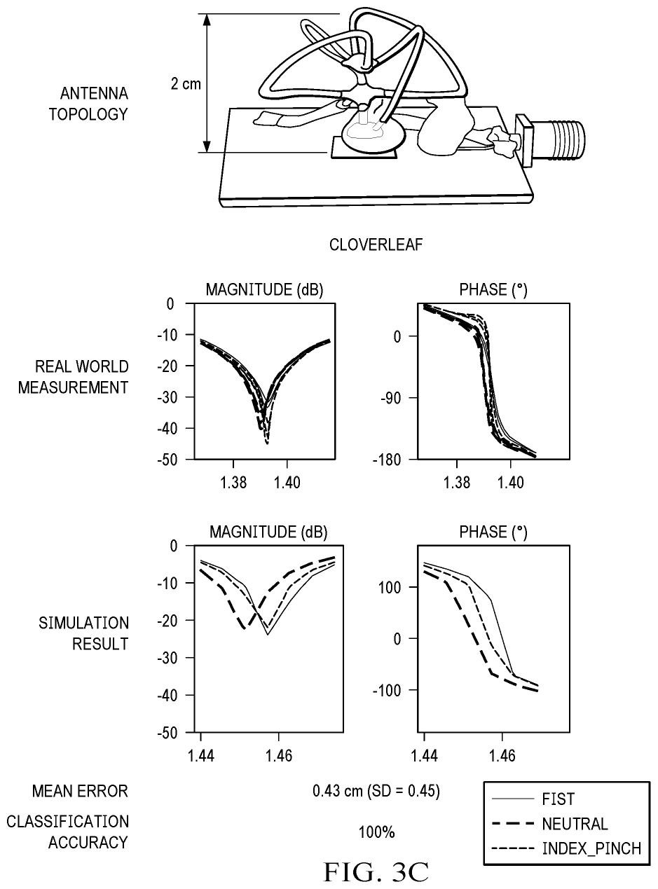

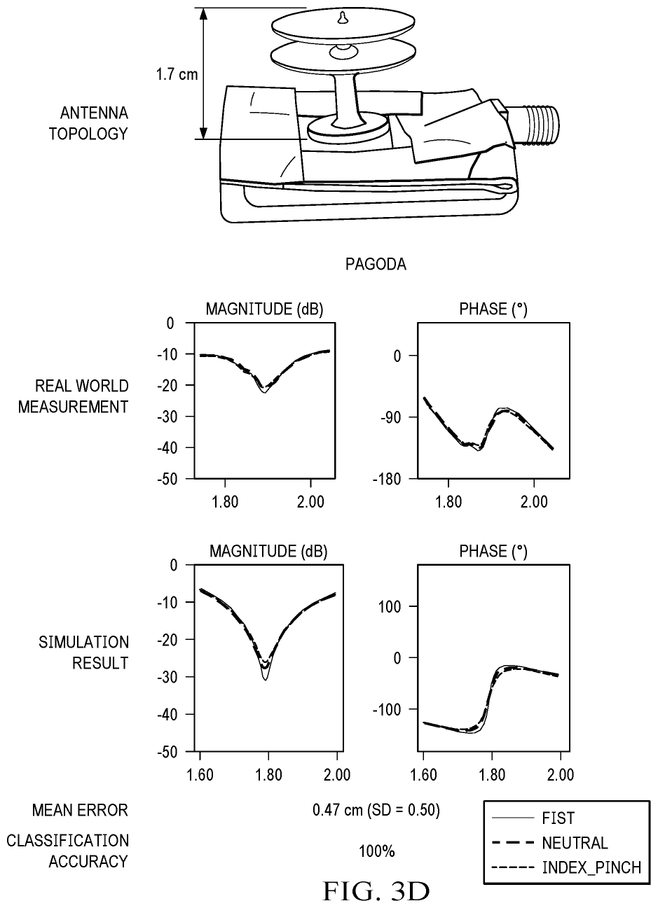

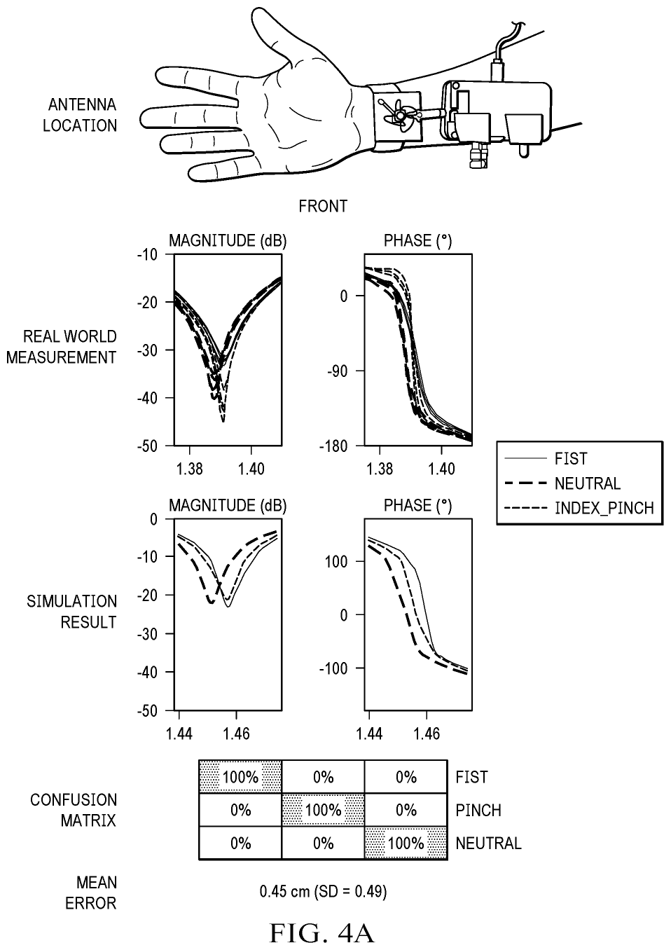

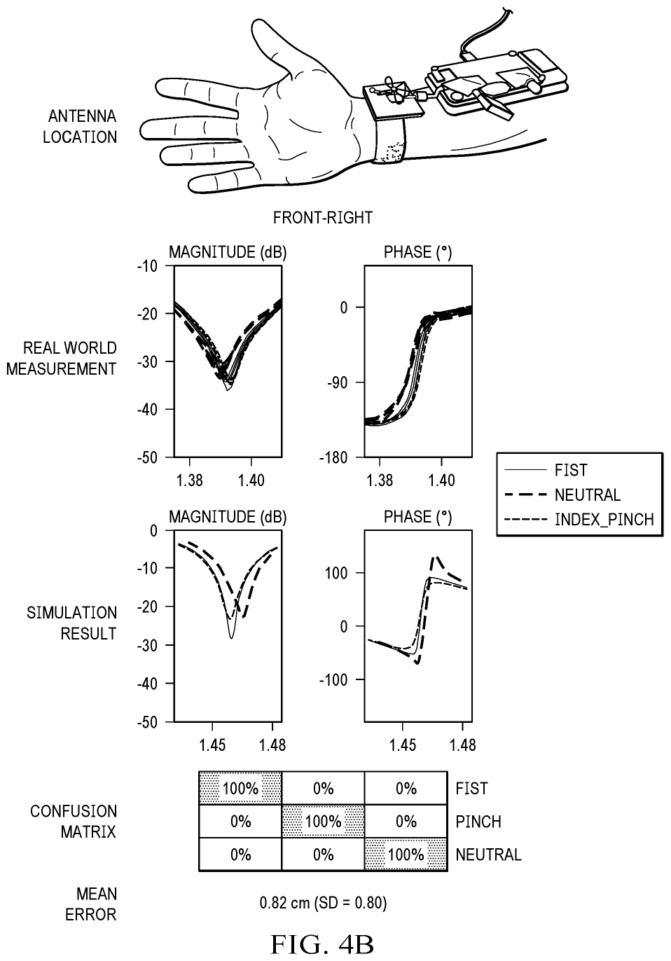

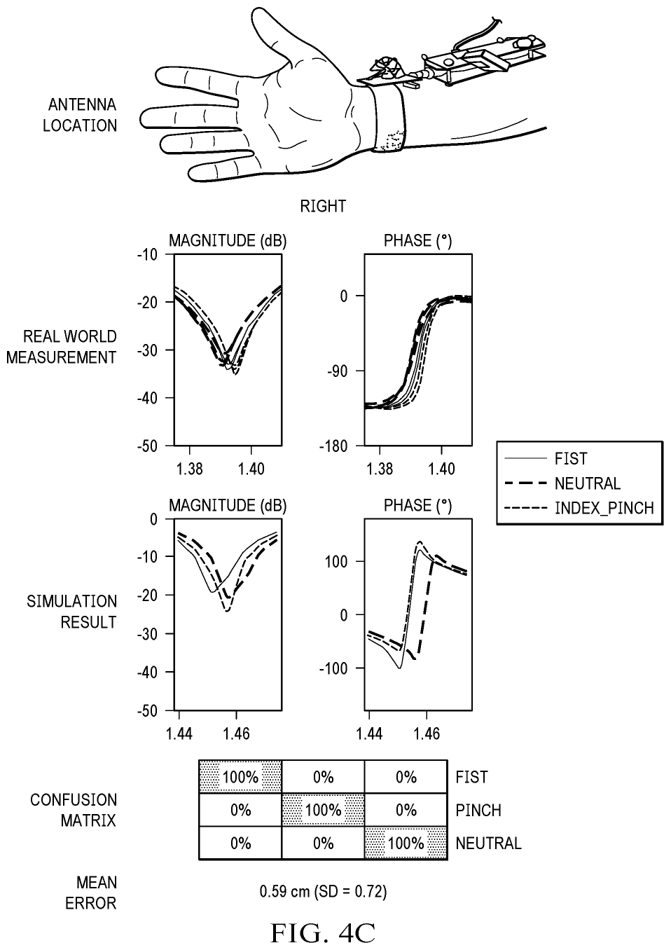

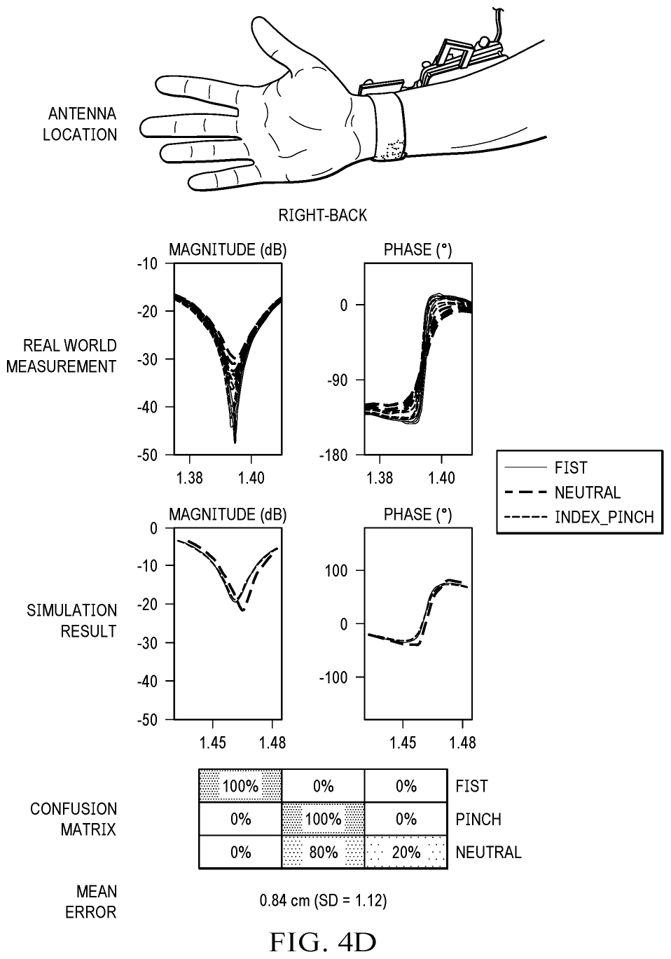

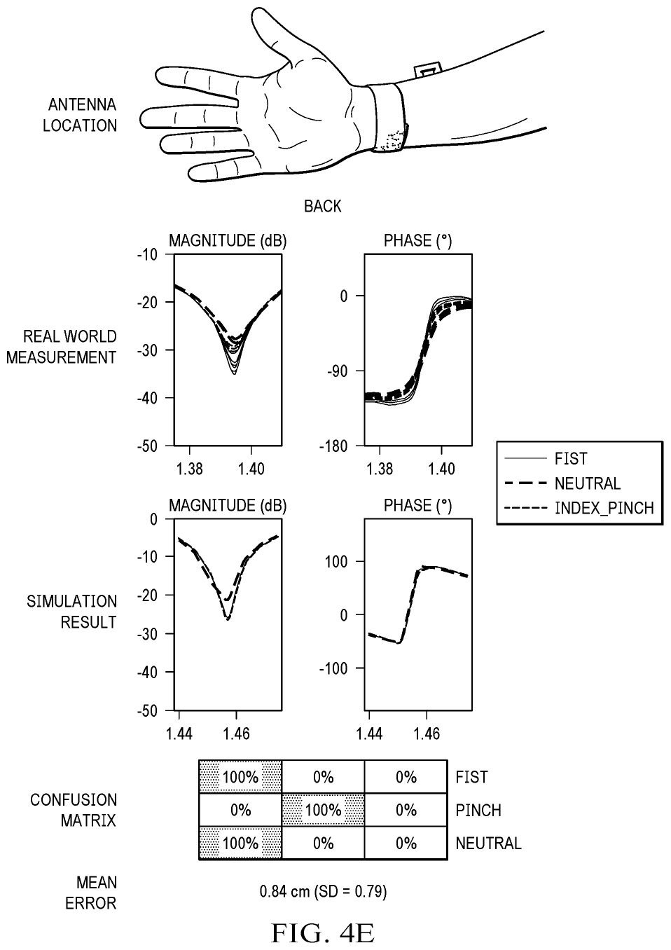

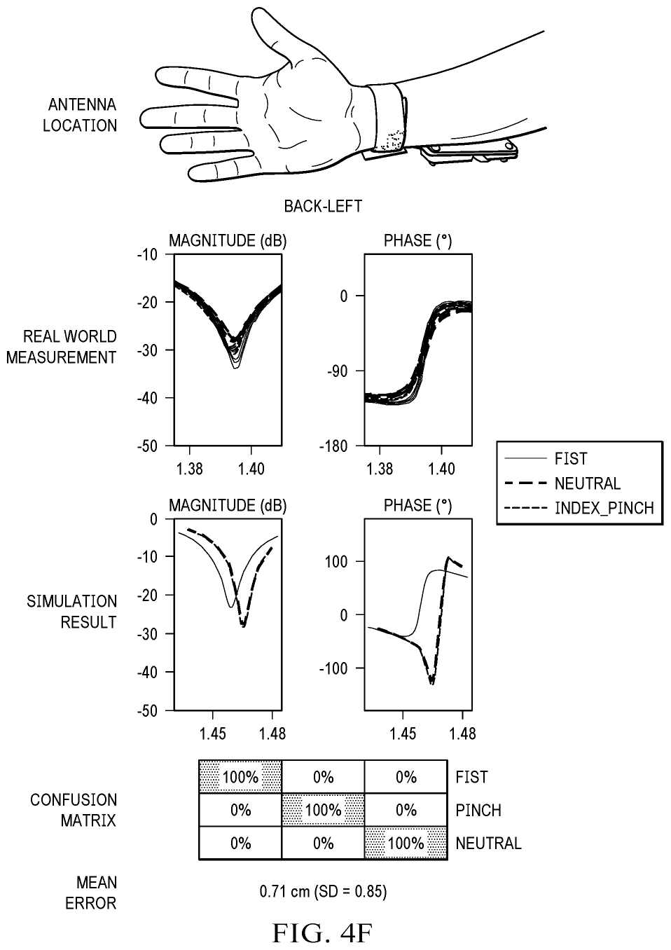

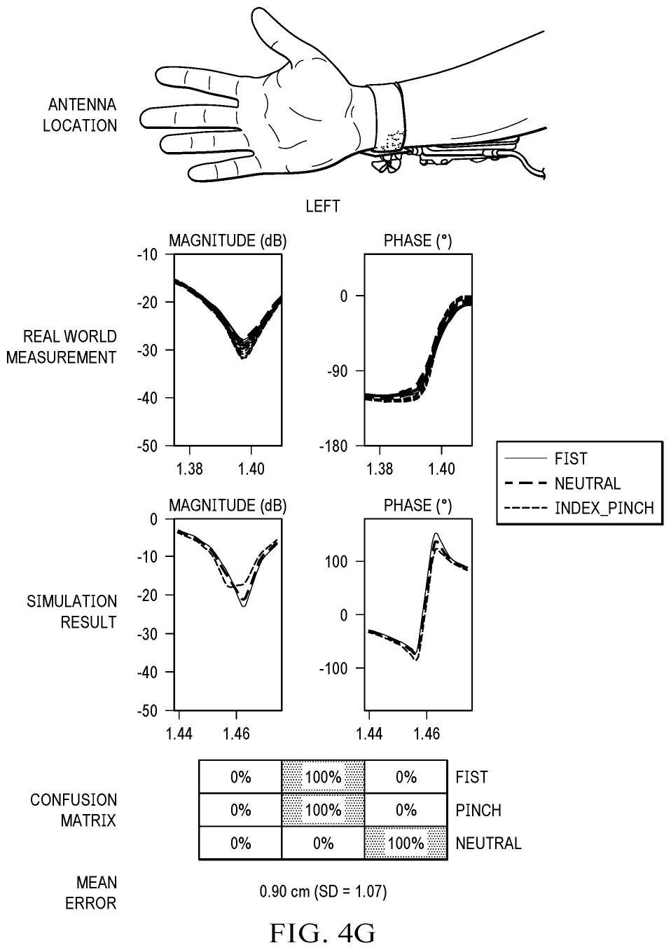

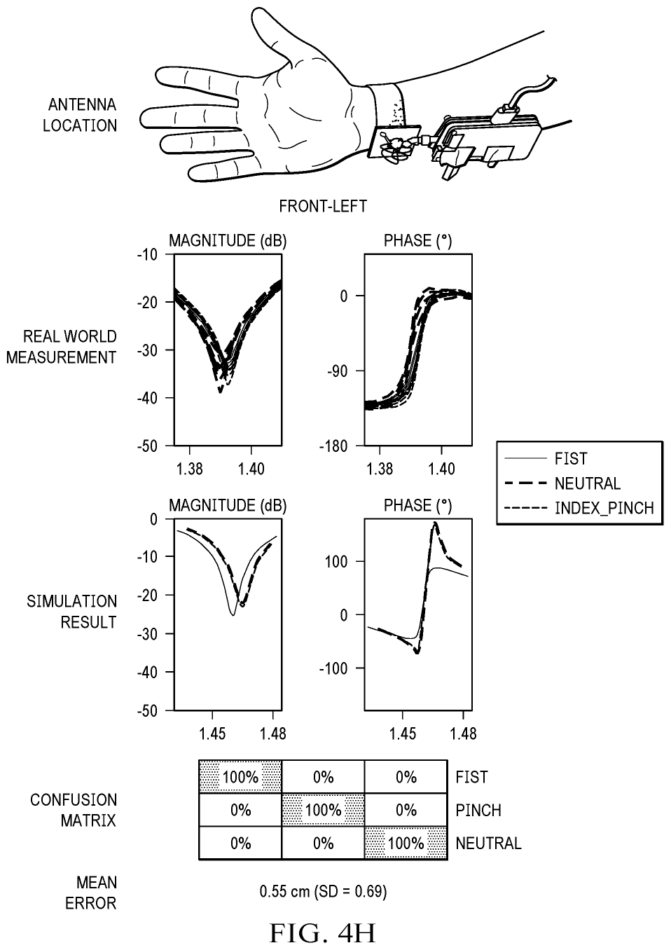

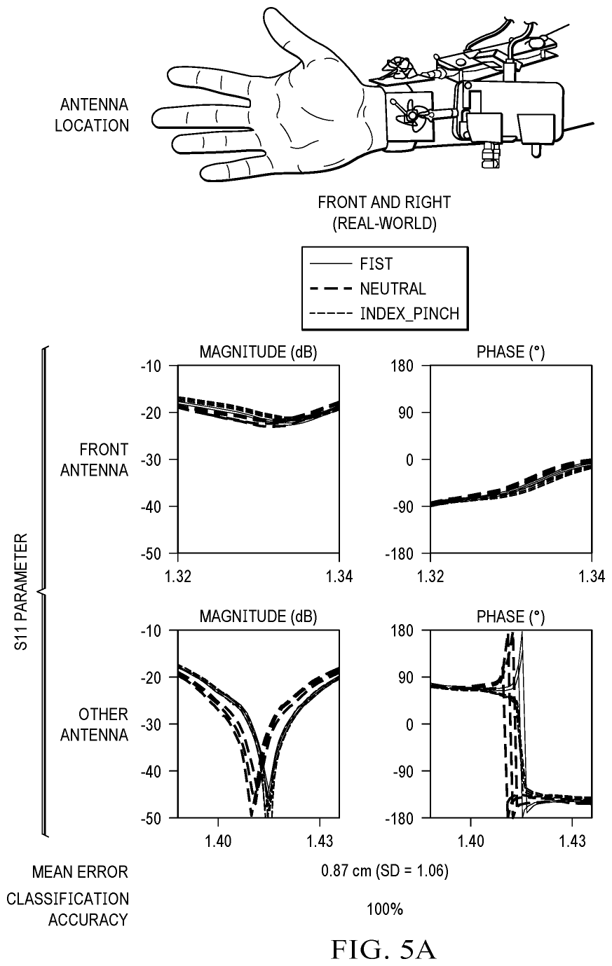

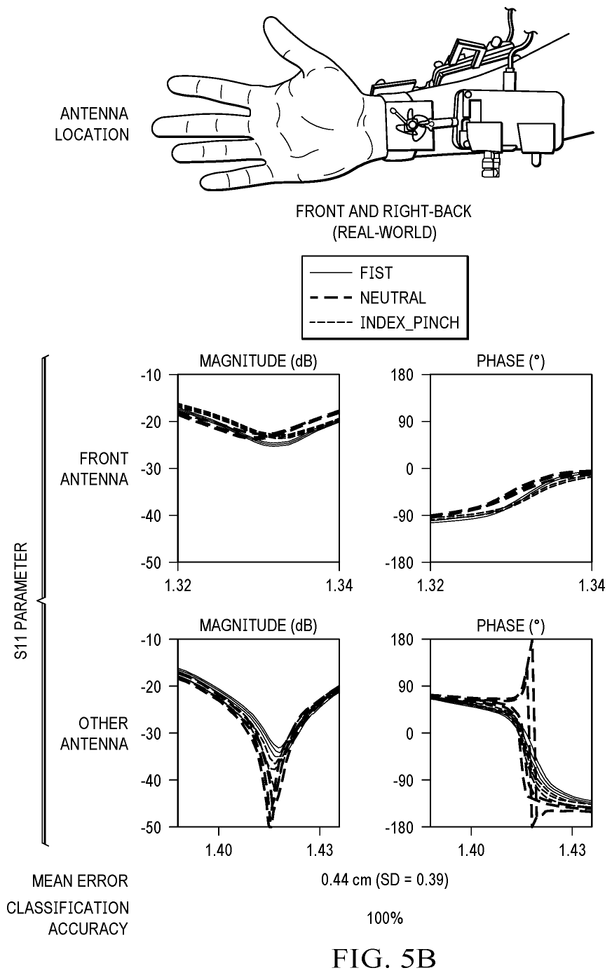

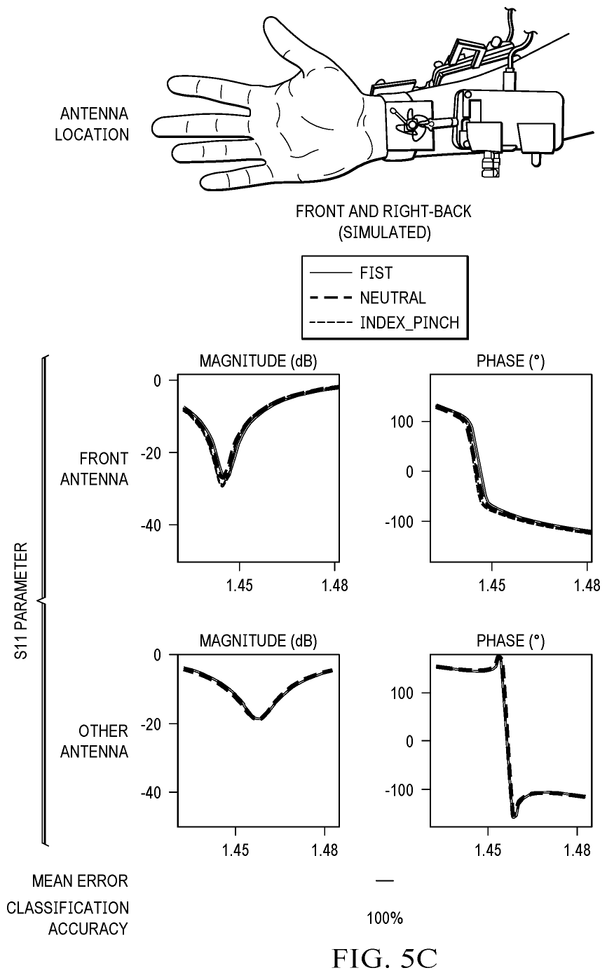

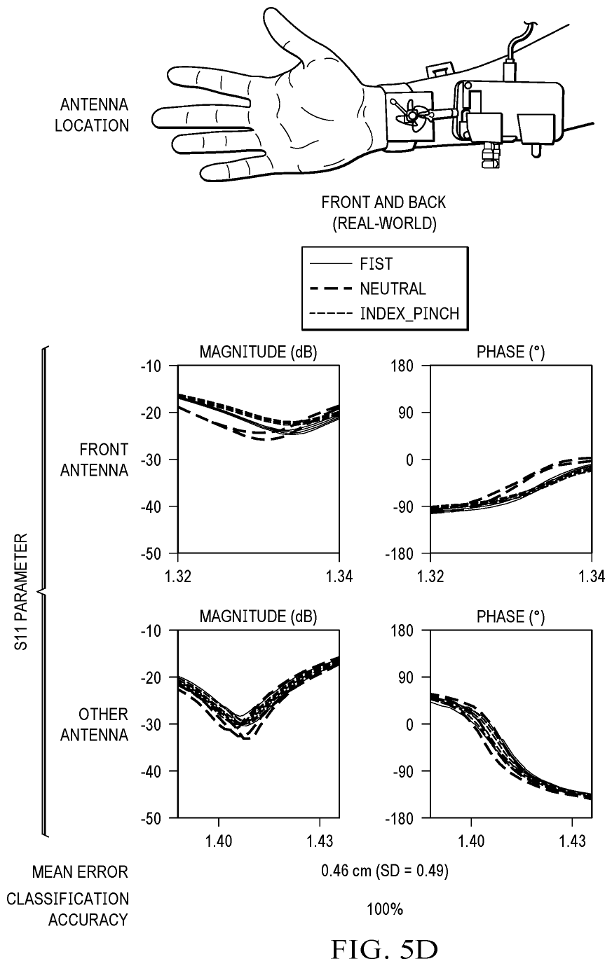

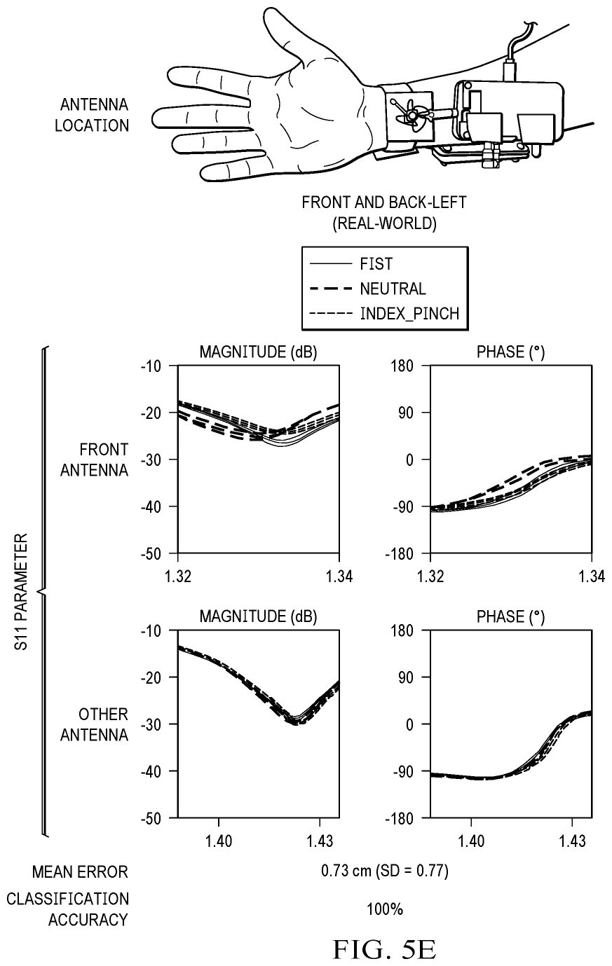

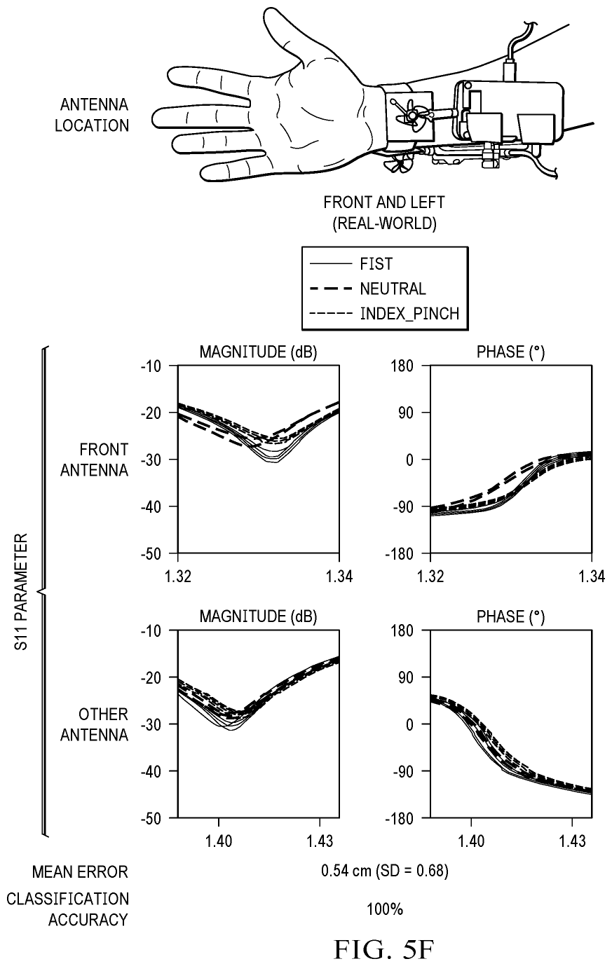

In the embodiment shown, antennas 101a, 101b are cloverleaf antennas with ground planes located at the front and left-back positions on the wrist, as described in reference to FIGS. 4 and 5. The design and dimensions of cloverleaf antennas 101a, 101b are shown in column three of FIG. 3. Antennas 101a, 101b are mounted to a support structure (e.g., thick acrylic) with features (e.g., cutouts) that allow elastic band 106 to loop through, permitting flexible antenna placement for a variety of wrist diameters. While it is desirable that antennas 101a, 101b have identical characteristics, in practice there will likely be small construction differences. In this example embodiment, the resonant frequencies of the front and left-back antennas 101a, 101b on the wrist are about 1.33 and about 1.39 GHz, respectively, while the magnitude of the S11 parameters at the resonant frequencies are about −30 and about −42 dB, respectively.

In the example shown, each antenna 101a, 101b is attached to its own dedicated VNA 102a, 102b (e.g., attached with a rigid SMA connector). Both VNAs 102a, 102b connect to a single processor 103 (e.g., a Raspberry Pi Zero 2). Processor 103 runs software that implements a machine learning model that is trained to predict hand poses. In an embodiment, VNAs 102a, 102b measure the S11 parameter (reflection coefficient/return loss). The S11 parameter, which is described in further detail below, describes the ratio between the returned RF signal and the incident RF signal reflected by an impedance discontinuity in the medium.

### Example Processing Pipeline

FIG. 1B is a block diagram of a hand pose tracking processing pipeline, according to an embodiment. The pipeline includes one or more antennas 101a . . . 101n, one or more VNAs and one or more processors 103. Processor(s) 103 runs software that implements feature extractor 107 and one or more machine learning models 108 (e.g., neural networks). Training data 109 is used to train machine learning models 108 to predict various hand poses.

In some embodiments, the software running on processor(s) 103 communicates with VNAs 102a, 102b over a serial bus (e.g., USB). To initialize itself, each VNA 102a, 102b is programmed to measure the return loss magnitude (±20 Mhz centered at 1.38 GHz) in 21 steps. The antenna resonant frequencies (lowest value of the return loss magnitude) are detected and each VNA re-centers itself on these lowest values (most often with a small phase shift) to maximize sensitivity. In some embodiments, VNAs 102a, 102b are configured to sense this frequency range continuously in an time-multiplexed fashion (to avoid interfering with one another), such that only one VNA is transmitting and measuring at a time. Each VNA measures return loss magnitude (21 data points) and phase shift (21 data points). As there are two VNAs in this example embodiment, a single complete frame of data contains 84 total data points. Accordingly, it takes approximately 410 ms to capture a complete frame of data points, resulting in a frame rate of 2.4 Hz.

For each of the 4 sets of values (two return loss magnitude arrays and two phase shift arrays), feature extractor 107 computes the first derivative (20 features×4), the index of the peak (1 feature×4), the mean, min, max and standard deviation (4 values×4). These computations result in 100 additional features available for input into a machine learning model(s) 108 (e.g., a neural network(s)). In some embodiments, using each VNA's 21 magnitude values and 21 phase shift values, the impedance at each frequency is computed, resulting in 84 additional features (21 real and 21 imaginary components×2 VNAs). For these additional features, the first derivative (20 features×4), mean and standard deviation (2 features×4) are computed. This results in another 172 features, for a grand total of 356 (84+100+172) features available as input into a machine learning model(s) 108. As described below, machine learning model(s) 108 are trained on training data 109 to predict hand poses based on the features using, for example, conventional backpropagation techniques.

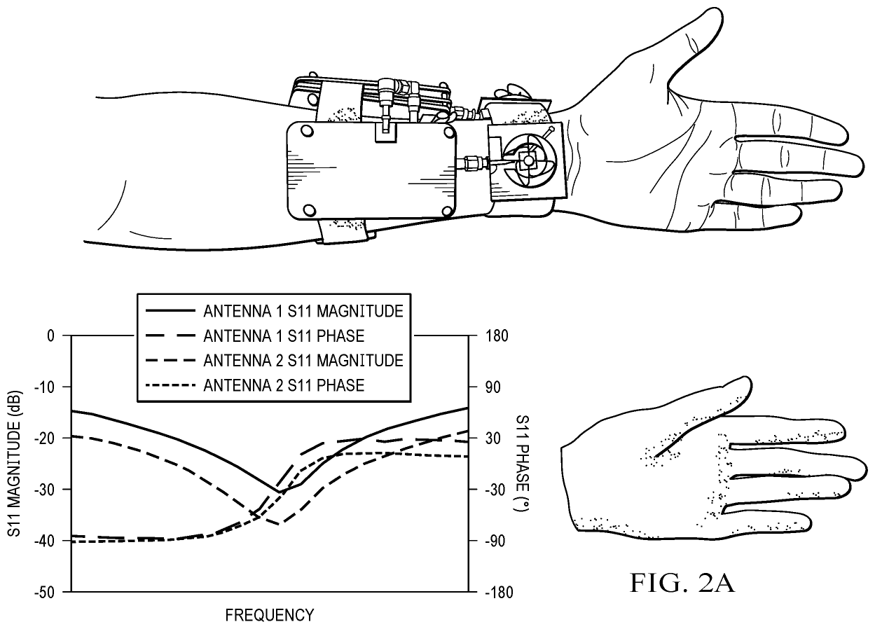

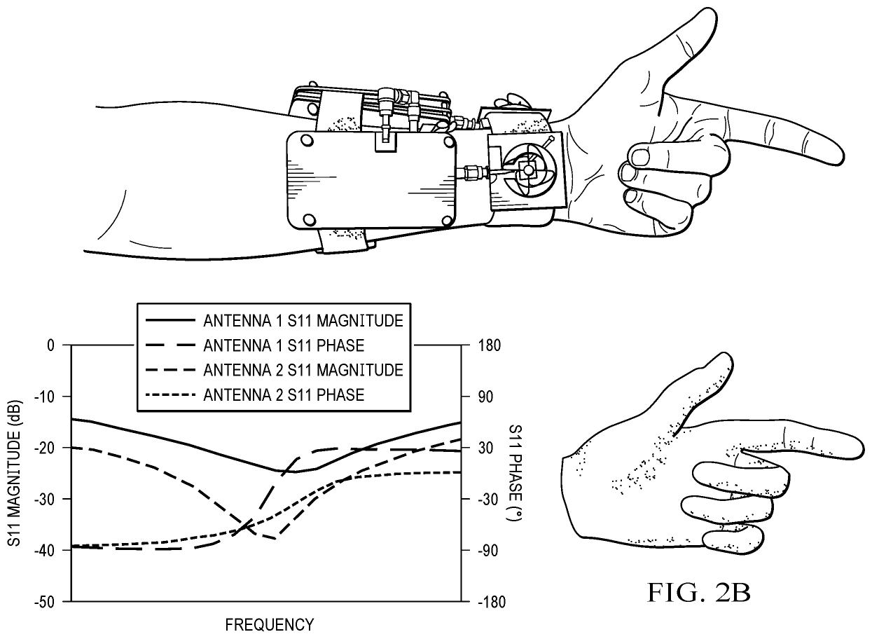

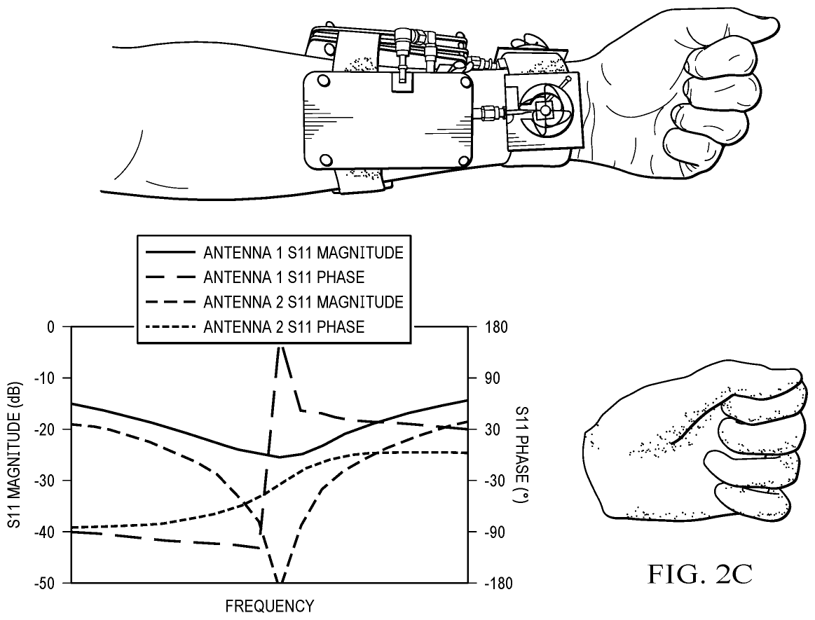

FIGS. 2A-2C illustrate the wrist-worn device measuring the swept frequency RF return loss of antennas 101a, 101b for three exemplary hand poses, which are used to pose a real-time three-dimensional (3D) hand model, according to an embodiment. The exemplary hand poses are open hand or neutral pose, thumb-to-index pinch pose and first pose. When a user's hand changes geometry (e.g., to form different hand poses), the expanded antenna ground plane formed by the user's tissue changes, therefore, changing the self-resonance of antennas 101a, 101b, consequently changing the impedance characteristics of antennas 101a, 101b observed at a predetermined frequency. Beneath each illustrated hand pose is a plot of the S11 parameter magnitude (dB) and phase (degrees) for antennas 101a and 101b as a function of frequency, and a 3D hand pose model. As can be observed, the three exemplary hand poses induced distinctive phase shifts and move the peak frequency in magnitude. As describe above, the S11 parameter magnitude and phase shift can be used to derive features for input into one or more machine learning models that are trained to predict hand poses.

### Example Input Modalities & Machine Learning Models

In an embodiment, the input modality is a three-dimensional (3D) hand pose as demonstrated in systems described in Yasha Iravantchi, Mayank Goel, and Chris Harrison. 2019. BeamBand: Hand gesture sensing with ultrasonic beamforming. In Proceedings of the 2019 CHI Conference on Human Factors in Computing Systems. 1-10, and Yang Zhang and Chris Harrison. 2015. Tomo: Wearable, low-cost electrical impedance tomography for hand gesture recognition. In Proceedings of the 28th Annual ACM Symposium on User Interface Software & Technology. 167-173.

In an embodiment, the input modality is 2DOF wrist angle input as demonstrated in WristWhirl described in Jun Gong, Xing-Dong Yang, and Pourang Irani. 2016. Wristwhirl: One-handed continuous smartwatch input using wrist gestures. In Proceedings of the 29th Annual Symposium on User Interface Software and Technology. 861-872 and RotoWrist described in Farshid Salemi Parizi, Wolf Kienzle, Eric Whitmire, Aakar Gupta, and Hrvoje Benko. 2021. RotoWrist: Continuous Infrared Wrist Angle Tracking using a Wristband. In Proceedings of the 27th ACM Symposium on Virtual Reality Software and Technology. 1-11.

In an embodiment, a third input modality is fine-grained finger input (sometimes called “micro-gestures”), described in: Jaime Lien, Nicholas Gillian, M Emre Karagozler, Patrick Amihood, Carsten Schwesig, Erik Olson, Hakim Raja, and Ivan Poupyrev. 2016. Soli: Ubiquitous gesture sensing with millimeter wave radar. ACM Transactions on Graphics (TOG) 35, 4 (2016), 1-19; Myoungseok Yu, Narae Kim, Yunho Jung, and Seongjoo Lee. 2020. A frame detection method for real-time hand gesture recognition systems using CW-radar. Sensors 20, 8 (2020), 2321; Gierad Laput and Chris Harrison. 2019. Sensing fine-grained hand activity with smartwatches. In Proceedings of the 2019 CHI Conference on Human Factors in Computing Systems. 1-13; Joseph Paradiso, Craig Abler, Kai-yuh Hsiao, and Matthew Reynolds. 1997. The magic carpet: physical sensing for immersive environments. In CHI′97 Extended Abstracts on Human Factors in Computing Systems. 277-278; and Arthur Sluyters, Sebastien Lambot, and Jean Vanderdonckt. 2022. Hand Gesture Recognition for an Off-the-Shelf Radar by Electromagnetic Modeling and Inversion. In 27th International Conference on Intelligent User Interfaces. 506-522.

Each of these input modalities requires a different model and training pipeline, as described in turn below.

### Continuous 3D Hand Pose Input Modality

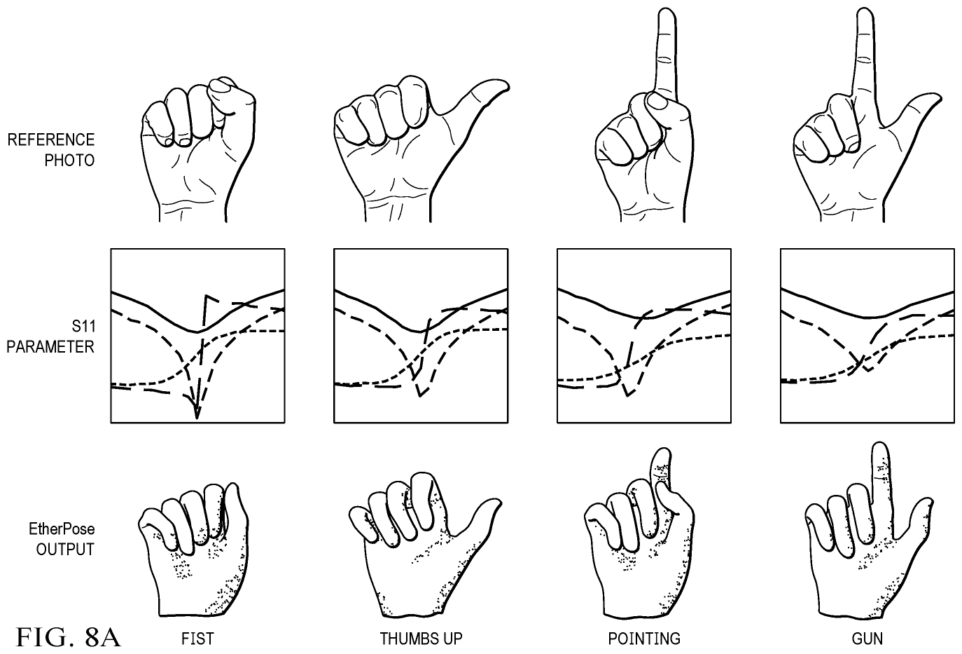

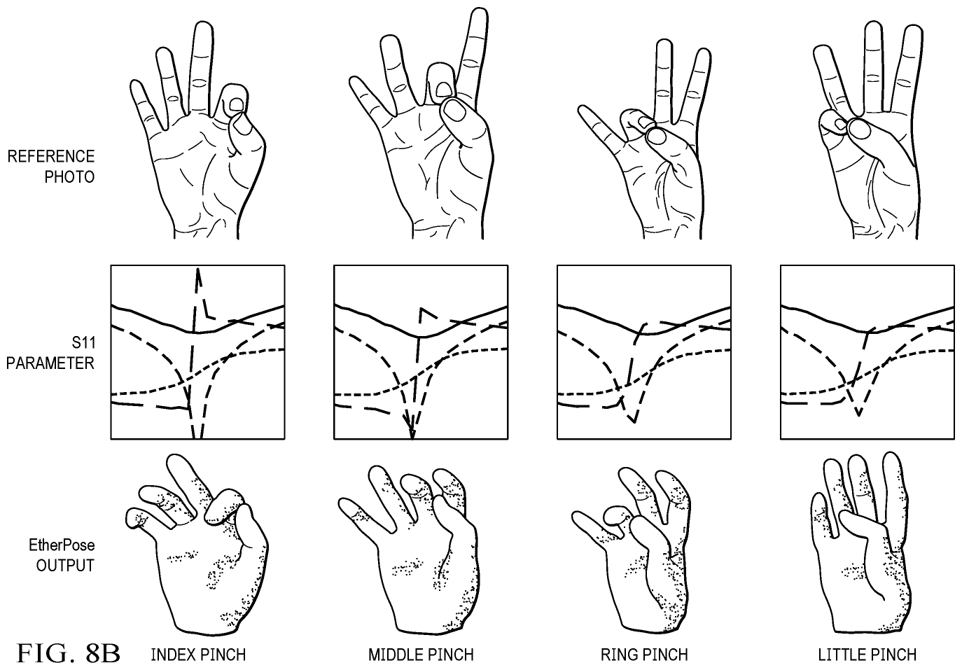

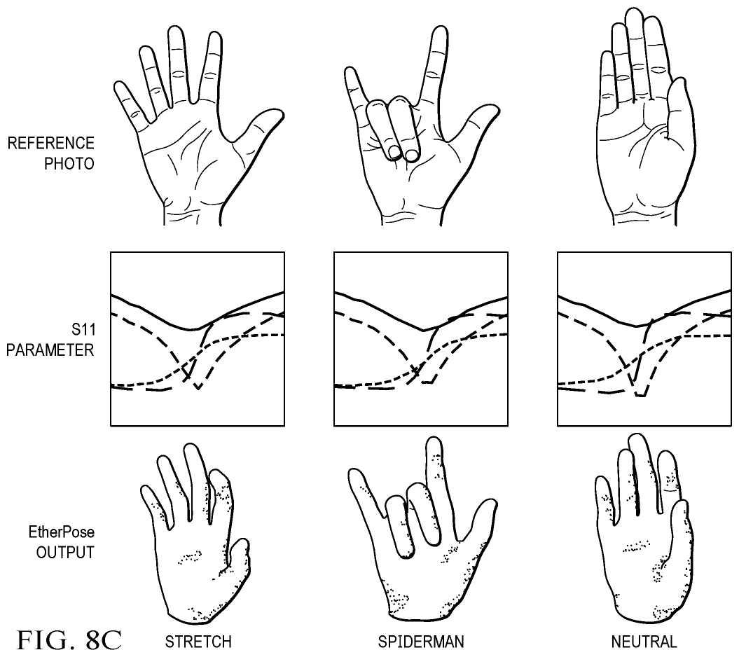

For the 3D model, in some embodiments a SciPy™ ExtraTreesRegressor model (default parameters, 100 estimators) is used to predict 21 hand keypoints. The input vector into the model includes the last N (e.g., N=3) frames of feature data. Ground truth 3D hand keypoints are captured using, for example, MediaPipe Hands described in Camillo Lugaresi, Jiuqiang Tang, Hadon Nash, Chris McClanahan, Esha Uboweja, Michael Hays, Fan Zhang, Chuo-Ling Chang, Ming Guang Yong, Juhyun Lee, et al. 2019. Mediapipe: A framework for building perception pipelines. arXiv preprint arXiv:1906.08172 (2019), and a webcam operating 30 cm below the user's hands. In some embodiments, the Mano Library, described in Javier Romero, Dimitrios Tzionas, and Michael J. Black. 2017. Embodied Hands: Modeling and Capturing Hands and Bodies Together. ACM Transactions on Graphics, (Proc. SIGGRAPH Asia) 36, 6 (November 2017), is used to produce the animated 3D hand meshes shown in FIGS. 2A-2C and FIG. 8 (bottom row).

### Continuous 2DOF Wrist Angle Input Modality

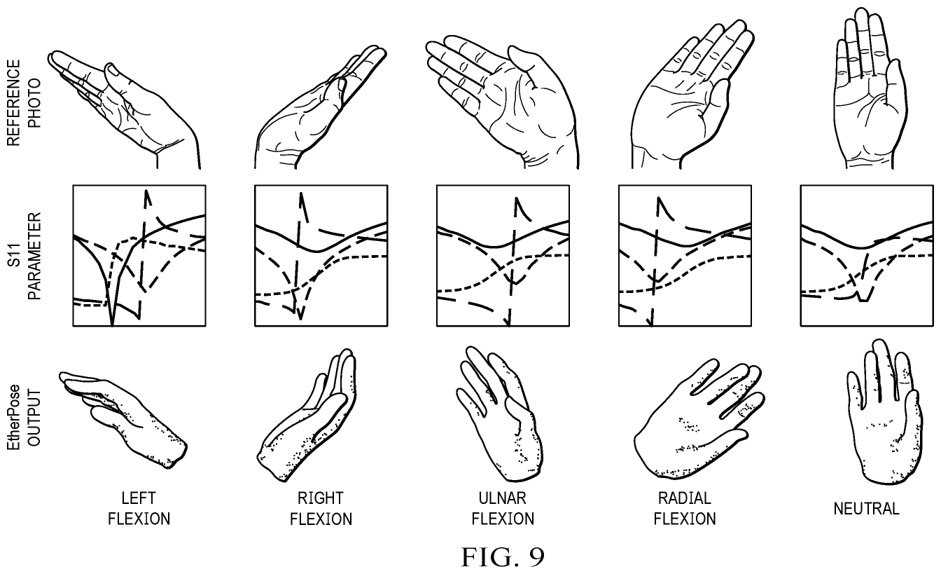

To capture training data for wrist angle, the same setup as 3D hand pose (MediaPipe Hands+webcam) is used. As a proxy for 2DOF wrist angle, the palm normal is computed using MediaPipe's wrist, index finger mcp, and pinky mcp keypoints. The ExtraTreesRegressor model (default parameters, 1000 estimators) is used to predict the wrist pitch and yaw (see FIG. 9, bottom row). In some embodiments, the most recent N (e.g., N=3) three frames of featured data from writs-worn device 100 are used as the input vector.

### Micro-Gestures Input Modality

As one example of micro-gesture input, the thumb's position relative to the other four fingers is tracked, held together and acting like a trackpad. The model (ExtraTreesRegessor, default parameters, 1000 estimators) is trained on discrete hand locations presented visually on a computer monitor. Once trained on this grid of data, the model can interpolate to provide continuous tracking. Some examples of micro-gestures include but are not limited to: hovering, touching and using the thumb and index finger like a slider.

### Antenna Topologies

FIGS. 3A-3D illustrate results from measurements and simulations across four antenna topologies, according to an embodiment. The four antennas topologies include: basic monopole, cloverleaf, pagoda and folded cylindrical helix. All four antenna topologies produces an anisotropic radiation pattern in-plane with the users' arm, which envelops the volume where the user's hand operates.

With these four antenna topologies, real world experiments were conducted to see how three exemplary hand poses (open hand, thumb-to-index pinch, first) altered the antennas self-resonance, and therefore its complex characteristic impedance. Additionally, matching software simulations were run for all antennas but the folded cylindrical helix antenna. For all of these experiments (real and simulated) the antenna position was held constant: centered on the arm, just below the wrist crease, which is defined as the “front” position on the wrist, as shown in FIGS. 4A-4H.

Referring to FIGS. 4A-4H, an overview of the real world experiments are shown. The third row is the simulated antenna S11 data (one curve for each hand pose), while the second row shows all 15 trials (5 repeats×3 frames) for each of the hand poses as performed by a real user. While there are minor differences between the simulated and real-world data, the main result is apparent. All antennas change their impedance characteristic in response to the different hand poses, though perhaps most dramatically with the cloverleaf antenna, with almost a 50 dB radiated at its resonant frequency.

To test how the measured signal impacted machine learning accuracy, five rounds of real hand pose data were used to train and test a continuous hand model (e.g., using leave-one-round-out cross validation). The model's pose predictions were compared against the MediaPipe-captured ground truth and the mean per-joint position error (MPJPE) was computed, which is reported in the fourth row of FIGS. 4A-4H. Additionally, a classification model was trained that predicts the three discrete hand poses, which is reported in the bottom row of FIGS. 4A-4H. All four antennas had 100% classification accuracy, and so confusion matrices are not shown.

Based on the real world experiments, all four antenna designs were able to accurately predict hand poses, especially in the discrete pose classification task. The monopole antenna performed best in a machine learning evaluation, but its inherently tall profile was a significant detractor. Balancing accuracy and feasibility, the cloverleaf antenna was used in wrist-worn device 100, which performed second best in machine learning evaluation, demonstrated the most salient differences in its S11 data and offered a compact geometry. In other embodiments, the other antenna designs may be used and/or a combination of different antenna designs.

In an embodiment, device 100 includes: 1) at least two antennas with different topologies; 2) at least two antennas with different resonant frequencies; 3) at least two antennas with different polarization; 4) at least two antennas with different antenna radiation patterns; 5) at least two antennas with different quality factors; 5) a distributed antenna array of two or more antennas; 6) at least two antennas that are coupled to the device such that they radiate in opposite directions.

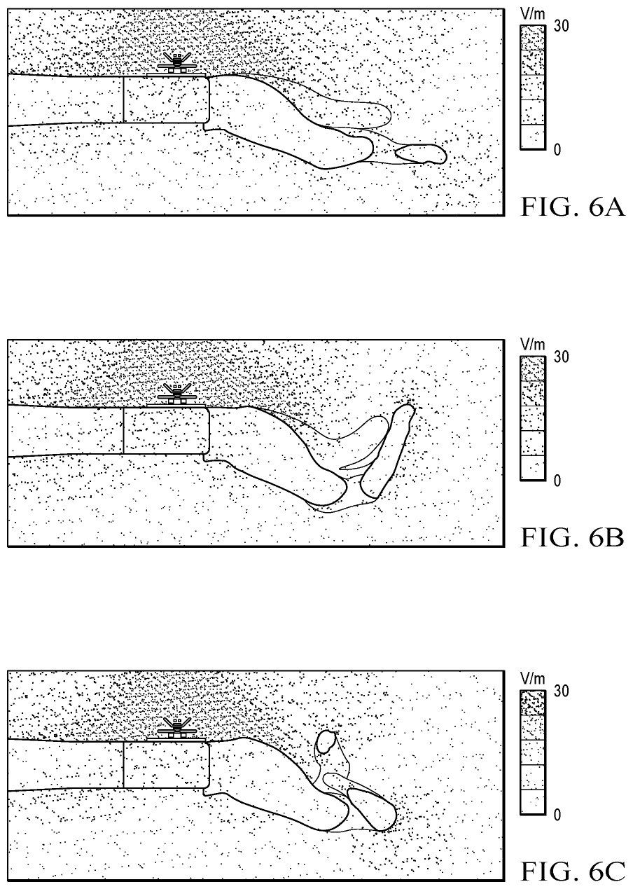

FIGS. 6A-6C illustrate simulation of electric field distribution for a cloverleaf antenna at the front position for three exemplary hand poses, according to an embodiment. To better understand how the cloverleaf antenna's electric field was being altered by the three hand poses the electric field distribution was simulated and rendered alongside the phantom. It can be observed that in the open hand or neutral hand pose, the electric field distribution at the fingers is reduced, with a small concentration at the middle finger tip. In the thumb-to-index pinch pose, the electric field is more evident along the length of the fingers, with an even higher concentration at the fingertip. Finally, in the first pose, a different electric field distribution is observed with high concentration at the thumb knuckle and index finger tip.

These electric field simulation results support the hypotheses that changes to antenna impedance characteristics are resultant from the coupled ground plane's (e.g., forearm and hand) morphology changes. If the extended coupled ground plane created by the forearm and hand would be electrically infinite (e.g., larger than several wavelengths), changes in the electric field distribution would not be noticed or appear in the antenna characteristic impedance.

### Antenna Location

With an antenna topology selected, the impact of body location on antenna signal was analyzed using a combination of software simulation and real world measurements. Holding other parameters constant, eight body placements were tested: front, front-left, left, left-back, back, back-right, right, and front-right. FIGS. 4A-4H show the real-world and simulated S11 plots across the eight positions, along with classification and mean joint position error. Coincidentally, the front position performed best, with 100% classification accuracy for the three exemplary poses and the lowest joint error (0.45 cm). The S11 plots also showed the most expressivity in response to the three hand poses. For these reasons, the front position was used in wrist-worn device 100.

### Secondary Antenna Location

FIGS. 5A-5F illustrate results from measurements and simulations of a first cloverleaf antenna placed at the front position on the wrist, and a second cloverleaf antenna placed at one of five other positions on the wrist, according to an embodiment. After selecting the front position to host a cloverleaf antenna, it was apparent there was sufficient space on the backside of the wrist to host a second antenna. However, as the two antenna will interact with one another, it was not as straightforward as selecting the next-best-performing antenna. To give more confidence and clarity in antenna selection, another set of simulations and real world measurements were run. This time, all conditions included a frontal cloverleaf antenna, and a second cloverleaf antenna were tested in five possible positions (left, left-back, back, right-back, and right). Front-left and front-right positions were not possible, as the antennas could not physically fit side-by-side on our wristband.

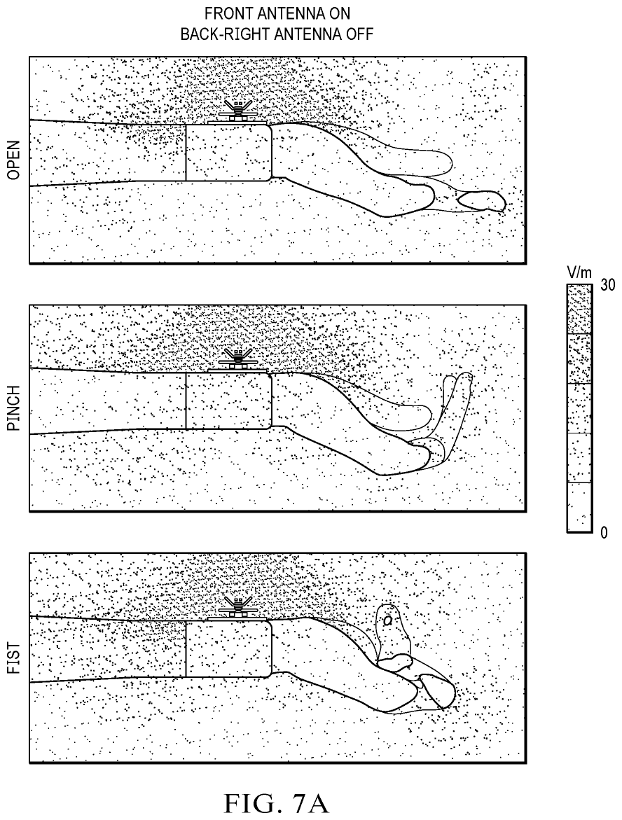

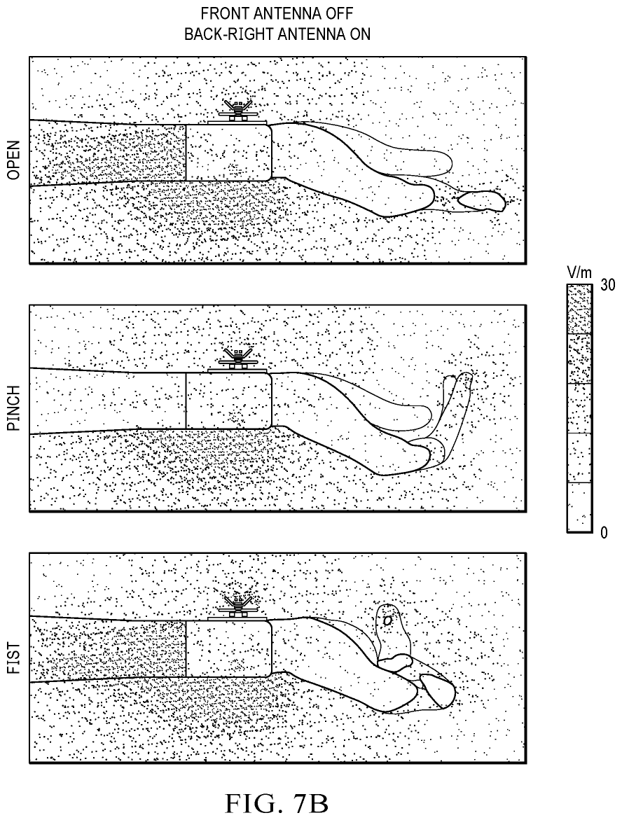

Among the five positions, the combination of front & right-back performed best (followed closely behind by front & back). In both cases, the three hand poses induced distinctive phase shifts, as well as move the peak frequency in magnitude. The machine learning accuracy was essentially unchanged using only a single front antenna. However, a two-antenna design was used for wrist-worn device 100 capture some hand configurations in an expanded pose set. FIGS. 7A and 7B show simulated electric field intensity distribution at resonance frequency, where one antenna is placed in the front-position and the secondary antenna is placed in the left-back position.

FIGS. 8A-8C illustrate eleven example hand poses that were used as hand pose “destination,” with training data 109 collected continuously for all intermediate pose states. The middle row shows an example S11 parameter sparkline captured in the corresponding pose, and the bottom row shows example hand pose output from the processing pipeline shown in FIG. 1B.

FIG. 9 illustrates five example wrist flexions that were used as wrist angle “destinations,” with training and testing data collected continuously for all intermediate pose states. The middle row shows an example S11 parameter sparkline captured in the corresponding pose, and the bottom row shows example hand pose output from the processing pipeline shown in FIG. 1B.

### Example Process

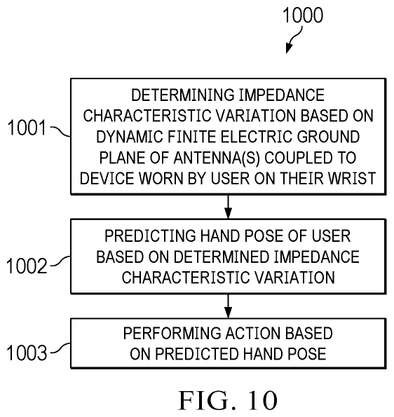

FIG. 10 is a flow diagram of a continuous hand pose tracking process (1000) using wrist-worn antenna impedance characteristics sensing, according to an embodiment. Process (1000) can be implanted by, for example, device 100 shown in FIG. 1.

Process (1000) includes: determining, with a wrist-worn device, an impedance characteristic variation based on a dynamic finite electric ground plane of at least one antenna coupled to the device (1001); predicting a hand pose of a user wearing the device on a their wrist based on the determined impedance characteristic variation (1002); and performing an action based on the predicted hand pose (1003). Each of these steps were previously described in reference to FIGS. 1-10.

### ADDITIONAL EMBODIMENTS

The device can include one or more antennas mounted at any suitable location on the wrist. The antennas can include any suitable topology. Any suitable input modality and machine learning model can be used to predict hand poses. In an embodiment, the device can be implemented in an SoC, system in package (SIP) or a chipset. In an embodiment, the device can be integrated into a smartwatch or other wearable host device, and can utilize existing antennas and/or processors of the host device.

Because small changes in the worn location, or hand shape/size can have a significant impact on our antennas' complex impedance characteristic, in some embodiments per-worn-session calibration is employed. For example, when the user's arms are operating in front of the user, such as in a virtual reality (VR) experience, device 100 works well. However, when the arm gets too close to the user's body (or any conductive object, such as a steel door), the antennas may begin to couple causing their impedance characteristics to change. Less severe is metal jewelry, such as rings, as they are already part of the ground plane. Accordingly, in some embodiments more directional antennas can be employed on the device 100 that emit towards the hands, instead of radiating outwards. Additionally, different antenna topologies (including mixed topologies on one band) and greater number of antennas can be used, including more compact antennas than the cloverleaf design. In some embodiments, flexible printed circuit board (PCB) antennas can be used to enable truly thin form factors that could be integrated into the strap of, e.g., a smartwatch with an ASIC in the watch body interfacing with a totally passive band.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location-based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

What is claimed is:

1. A method comprising:
determining, with at least one processor of a wrist-worn device, an complex impedance characteristic variation based on a dynamic finite electric ground plane of at least one antenna coupled to the device; and
predicting, with the at least one processor, a hand pose of a user wearing the device on a their wrist based on the determined complex impedance characteristic variation.

2. The method of claim 1, wherein determining the complex impedance characteristic variation comprises:
measuring return loss magnitude and phase shift for the at least one antenna as a function of frequency; and
determining the complex impedance characteristic variation from the measured return loss magnitude and phase shift.

3. The method of claim 1, wherein the predicting is implemented using a machine learning model.

4. The method of claim 3, further comprising:
measuring return loss magnitude and complex impedance magnitude and phase shift for the at least one antenna as a function of frequency, and determining the complex impedance characteristic variation from the measured return loss magnitude and complex impedance magnitude and phase shift;
computing a first derivative of the return loss magnitude and complex impedance magnitude and phase shift;
determining an index of a peak return loss magnitude;
computing a mean of the return loss magnitudes and complex impedance magnitude and phase shifts;
computing a minimum and maximum of the return loss magnitudes and complex impedance magnitude and phase shifts;
computing a standard deviation of the return loss magnitudes and complex impedance magnitude and phase shifts; and
aggregating the first derivative, index of peak magnitude, minimum, maximum and standard deviation into an input feature vector; and
providing the input feature vector to the machine learning model.

5. The method of claim 3, wherein a hand input modality for training the machine learning model include images of hand poses.

6. The method of claim 3, wherein a hand input modality for training the machine learning model include images of wrist angles.

7. The method of claim 3, wherein a hand input modality for training the machine learning model include images of discrete hand locations.

8. An apparatus comprising:
at least one antenna;
at least one processor coupled to the at least one antenna, the processor configured to perform operations comprising:
determining a complex impedance characteristic variation based on a dynamic finite electric ground plane of at least one antenna coupled to the device; and
predicting a hand pose of a user wearing the device on a their wrist based on the determined complex impedance characteristic variation.

9. The apparatus of claim 8, wherein the apparatus includes at least two antennas with different topologies.

10. The apparatus of claim 8, wherein the apparatus includes at least two antennas with different resonant frequencies.

11. The apparatus of claim 8, wherein the apparatus includes at least two antennas with different polarization.

12. The apparatus of claim 8, wherein the apparatus includes at least two antennas with different antenna radiation patterns.

13. The apparatus of claim 8, wherein the apparatus includes at least two antennas with different quality factors.

14. The apparatus of claim 8, wherein the apparatus includes a distributed antenna array of two or more antennas.

15. The apparatus of claim 8, wherein the apparatus includes at least two antennas that are coupled to the device such that they radiate in opposite directions.

16. The apparatus of claim 8, wherein the at least one antenna is a cloverleaf antenna.

17. The apparatus of claim 8, wherein the apparatus is a smartwatch.

18. The apparatus of claim 8, further comprising an attachment mechanism for attaching the apparatus to a wrist.

19. A non-transitory, computer-readable storage medium storing instructions that when executed by the at least one processor, cause the at least one processor to preform operations comprising:
determining a complex impedance characteristic variation based on a dynamic finite electric ground plane of at least one antenna coupled to a wrist-worn device; and
predicting a hand pose of a user wearing the device based on the determined complex impedance characteristic variation.

20. The non-transitory, computer-readable storage medium of claim 19, wherein determining the complex impedance characteristic variation comprises:
measuring return loss magnitude and complex impedance magnitude and phase shift for the at least one antenna as a function of frequency; and
determining the complex impedance characteristic variation from the measured return loss magnitude and phase shift.
